(19) United States
(12) Patent Application Publication
(10) Pub. No.: US 2008/0086603 A1
(43) Pub. Date: Apr. 10, 2008

(54) Memory management method and system

(76) Inventors: Vesa Lahtinen, Kangasala (FI); Kimmo Kuusilinna, Tampere (FI); Jari Nikara, Tampere (FI); Jukka M. Nurminen, Nokia (FI)

Correspondence Address: Hollingsworth & Funk, LLC;Suite 125, 8009 34th Avenue South, Minneapolis, MN, 55425, US

(21) Appl. No.: 11/543,688

(22) Filed: Oct. 5, 2006

(51) Int. Cl. G06F 12/00

(52) U.S. Cl. 711/147; 711/170

(57) ABSTRACT

Systems, apparatuses and methods for efficient logical memory management using centralized memory management. One embodiment involves allocating a first memory region to a first subsystem, generating a region code associated with the allocated memory region, storing the region code in connection with an address of the memory region, and defining the first subsystem as a first owner for the memory region by storing a unique subsystem identifier together with the region code in a parameter table. In this manner, a memory region may be globally addressed by its region code and an ownership to a subsystem is defined and stored.

### FIELD OF THE INVENTION

The invention pertains to the field of memory management, and particularly to an intelligent memory management unit and a method for centrally managing global memory resources.

### BACKGROUND ART

Memory use in devices such as mobile terminals is a wide field of research and optimization attempts. In particular, efficient use of available resources needs to be considered in order to optimize speed, size and cost of a memory unit.

In current mobile terminals, which are considered by way of example here, a significant part of the component silicon die area is occupied by memory. Moreover, the portion of memory versus logic is constantly growing. Yet only a fraction of the memory available in systems is actively used at a time. This is caused by designs and architectures where large memory portions are permanently reserved for dedicated purposes and processes, and by the fact that runtime allocation of unused memory portions for other purposes is in most cases difficult or even impossible. When large memory elements are necessary in mobile terminals, this involves further problems. Energy consumption is a considerable limitation and design aspect for most devices and has even more importance in mobile terminals with only limited power resources, such as batteries.

### SUMMARY OF THE INVENTION

A method and system are provided for efficient logical memory management using a centralized memory management unit. This is according to a first aspect of the invention achieved by a method comprising allocating a first memory region to a first subsystem; generating a region code associated with said allocated memory region; storing said region code in connection with an address of said memory region; and defining said first subsystem as a first owner for said memory region by storing a unique subsystem identifier together with said region code in a parameter table. In this way, a memory region may be globally addressed by its region code and an ownership to a subsystem is defined and stored in this parameter table. The physical address is not necessary to address a memory region, and therefore such a method may also hide the actual physical memory structure from the requesting subsystems and provide a unified logical memory view to these subsystems.

In one embodiment, the allocating may comprise receiving a request for memory resources from said subsystem; allocating a memory region corresponding to said request for said subsystem; and transmitting said generated region code of said memory region to said subsystem as an acknowledgement.

Said request for memory resources may in some embodiments of the invention comprise at least a required size parameter and a logical starting address parameter for said memory region.

In various exemplary embodiments, the method may further comprise transferring the ownership of said memory region to a second subsystem by changing said stored subsystem identifier at said parameter table. A transfer of memory region ownership between subsystems may thus be used instead of copying memory region contents, thus leading to reduced effort in memory management.

In some embodiments, said ownership transfer of said memory region comprises transmitting an ownership transfer request for said memory region by said first subsystem to a central memory management unit; transmitting a region parameter message from said first subsystem to said second subsystem; and said second subsystem transmitting an update ownership request for said memory region to said memory management unit.

In certain embodiments, the ownership transfer request includes said subsystem identifier of said first subsystem and said assigned region code of said memory region to be transferred.

The update ownership request may in some embodiments of the invention include as parameters at least said subsystem identifier of said second subsystem, said region code of said transferred memory region and a logical starting address of said memory region of said second subsystem, and wherein said parameters were received in said region parameter message. In exemplary embodiments the region transfer message is communicated between subsystems, that is, the IMMU is not involved in the transfer. For example the region parameter message is sent by the first subsystem and received by the second subsystem.

In various embodiments, said memory management unit may remove said subsystem identifier indicated in said ownership transfer request from said stored parameter table.

The method may in certain embodiments further comprise the memory management unit updating said stored parameter table according to said parameters included within said update ownership request.

Furthermore, in some embodiments said memory management unit may block any memory access for a specific subsystem to a memory region if the subsystem identifier of said specific subsystem does not match at least one subsystem identifier stored in connection with the region code of said memory region. If desired, such a feature may be utilized to control access to memory regions and protect certain regions.

In various embodiments of the invention, said parameter table stored at said memory management unit comprises one or more of the following values for at least one memory region: memory region size, memory region code, owner identifier, logical starting address of said memory region, physical starting address of said memory region, protection flag, hard-coded flag.

The method may further comprise in exemplary embodiments a changing the size of an allocated memory region by updating a region size parameter stored in said parameter table, and adding an entry to said parameter table comprising parameters of a new memory region, wherein said new memory region is a part of said allocated memory region. This allows splitting an allocated memory region into two parts if required.

According to an further aspect of some embodiments of the invention, a system is provided comprising at least one subsystem, at least one memory unit, a memory management unit connected to said at least one subsystem and said at least one memory unit, having a stored parameter table comprising memory allocation related parameters; and at least one data interface for communication between said at least one memory unit and said at least one subsystem via said memory management unit, wherein said memory management unit is configured to generate and store unique region codes for each memory region of said at least one memory unit that is allocated to one of said at least one subsystems. Such a system may enable smaller system sizes and with it also lower system cost. Also, the use of a memory management unit and region codes for efficient memory management may reduce energy consumption.

In some embodiments, the at least one subsystem is a logic processing semiconductor die.

In various exemplary embodiments, said at least one memory unit may be a DRAM module. However, other types of memory modules may be used as suitable; also, several different types of memory modules could be used together.

According to exemplary embodiments of the invention the one memory unit is attached to said at least one subsystem by a face-to-face-connection. A face-to-face connection means that (at least) two dies are arranged in a single chip package such that their respective active die faces are in direct contact. Other 3D integration techniques may also be utilized for arranging and connecting several dies together in a chip package or on a single chip substrate, respectively. These several dies may then e.g. be manufactured by different production techniques. Various methods such as silicon-through-VIAs may be utilized to form a system out of these connected dies.

According to a further aspect of the invention, an apparatus is provided, comprising a system as described above. Such an apparatus may e.g. be some mobile/portable device, such as a mobile communication terminal, or any other apparatus that might benefit from efficient memory usage, such as personal or laptop computers, media players, and many other devices. Also, a computer readable medium may be provided comprising computer program code configured to perform some or all elements of the various exemplary method embodiments as explained above when executed on a processor.

According to a further aspect of the invention, a system is provided comprising means for allocating a first memory region to a first subsystem; means for generating a region code associated with said allocated memory region; means for storing said region code in connection with an address of said memory region; and means for defining said first subsystem as a first owner for said memory region by storing a unique subsystem identifier together with said region code.

In some embodiments, said system may further comprise means for transferring ownership of said memory region to a second subsystem by changing said stored subsystem identifier at said parameter table.

All of the above examples and embodiments may be combined with each other and modified in various ways, as will be understood in view of the following detailed explanations and figures.

### BRIEF DESCRIPTION OF THE DRAWINGS

In the following, exemplary embodiments of the invention will be described with the aid of the accompanying figures, where

FIG. 1 illustrates a general logical structure of an exemplary memory system according to the invention;

FIG. 2 is an exemplary parameter table that may be used be a memory management unit;

FIG. 3a-b are a sequence chart of allocation and deallocation of a memory region to a subsystem according to an exemplary embodiment of the invention;

FIG. 4 is a sequence chart of a memory region transfer between two subsystems according to an exemplary embodiment of the invention; and

FIG. 5 is a schematic view of an exemplary implementation for a system of the invention.

### EXEMPLARY EMBODIMENTS OF THE INVENTION

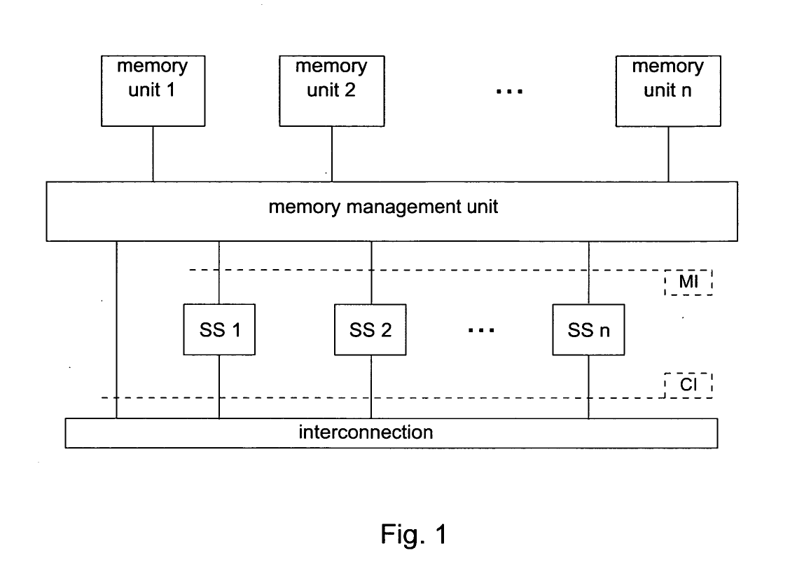

In FIG. 1, the general logical architecture view of an inventive embodiment is illustrated. As shown, several memory units 1 to n (n being any integer) are connected and controlled via an intelligent memory management unit (IMMU). Memory management unit and the plurality of memory units form a memory system providing storage resources to a device and its subsystems. The actual number of memory units is not important and may be chosen according to operating demands to the memory system and other factors. In principle, only one memory unit might also be sufficient.

Memory is provided for various subsystems of the overall device system. Such subsystems, designated SS 1 to SS n in FIG. 1, may be several components of a device which have their own dedicated tasks and may in general be designed separately. Subsystems may also be understood as processes, software entities or similar structures that require memory resources. As will be shown below, a subsystem may be incorporated on a separate logic semiconductor die of a chip package. Alternatively, several subsystems could be operated on a single die. The subsystems are logically interconnected via a control interface CI and also logically connected to the memory management unit via a memory interface MI. Both interfaces are shown as a dotted line in FIG. 1. There is no direct logical connection between the memory units and the subsystems, but that does not necessarily rule out physical connections. All data transfers between the memory units and the subsystems are effected via the memory interface MI in the example shown. Control messages between subsystems and between the memory management unit and subsystems are passed through the control interface CI. As implied by the logical connection on the far left of FIG. 1, the IMMU may also be seen as another subsystem with own dedicated interface to memory.

The memory management unit provides a unified view of the memory system for all subsystems regardless of the actual physical memory implementation. The provided functions may be, amongst others, allocation and deallocation of memory regions to subsystems, transfer of memory region ownership from one subsystem to another (which will be explained in detail below), and protection of memory regions against undesired access.

One aspect of the invention is the defining of ownerships for memory regions by the memory management unit. The owner of a memory region may thus be understood as a subsystem or component that is allowed to use the respective memory region for any procedures, such as standard read/write processes. Several owners may be assigned to a single memory region and thus be granted access to the same memory region, or a memory region may also not have a current owner and would be available for a new ownership registration on request. Ownership and related features of memory resources for subsystems are controlled by the intelligent memory management unit IMMU by using a defined region code for each allocated memory region. Some portions of the overall memory resources could still be permanently or temporarily dedicated to specific tasks and not be available in the memory allocation and transfer process, e.g. for tasks that require strict performance guarantees or are exceptionally demanding in view of performance. Specific examples of memory management procedures according to the invention will be presented in more detail below.

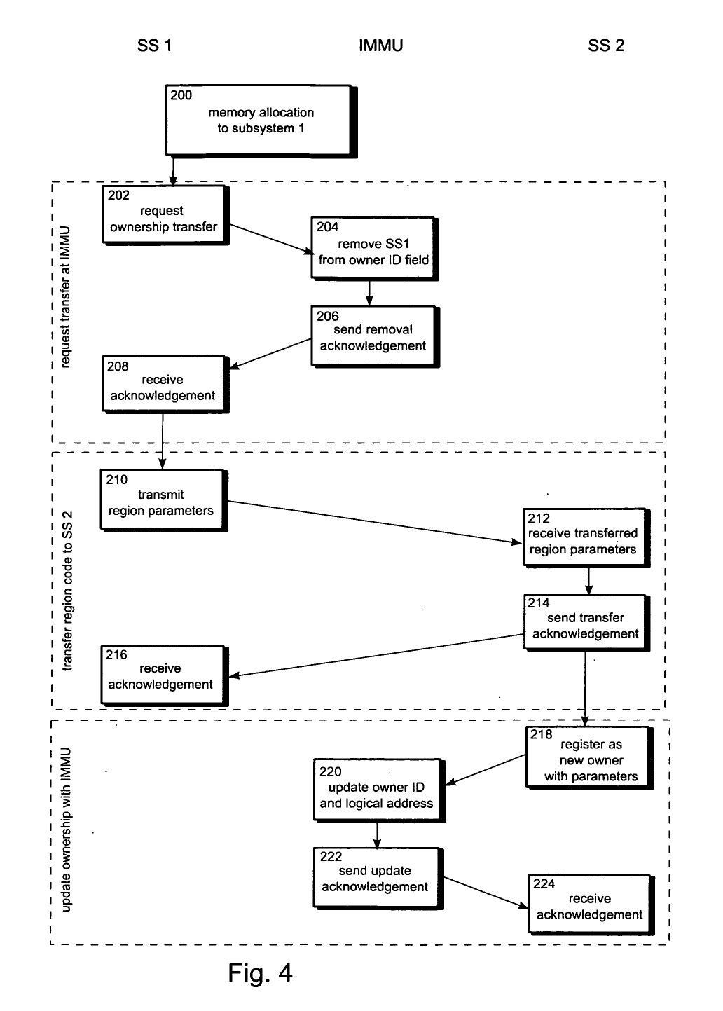

Several parameters may be used by the IMMU and in messages between subsystems, IMMU and memory units for efficient memory management according to exemplary embodiments of the invention. These parameter values may in one embodiment be stored in a table at the memory management unit to keep track of all controlled memory resources. Possible parameters are:
Region code: A region code is associated with each allocated memory region to identify these regions. The region code may be implemented as a running number unique within the memory system. In that case, e.g. numbers could be assigned in the order of allocation, and a value of zero (0) may be used to identify an unallocated region. However, these values are just one possible example, and other ways of assigning a well-defined region code to an allocated memory region are conceivable.
Owner ID: For purposes of identifying the current owner of a specific memory region, each subsystem that is controlled via the memory management unit is given a unique subsystem identifier. This may e.g. be an integer that is assigned to all subsystems arbitrarily or according to a given order. The owner ID parameter stored at the IMMU then indicates the current owner of a memory region. If a memory region is unallocated or being transferred to another subsystem and thus does not have a current owner, this may for example be indicated by a value of zero. Also, a memory region that is not dedicated to a single subsystem (that is, not protected as defined below) may have more than one owner at a time.
Logical starting address: a subsystem may use its own logical address space for addressing memory regions via the memory management unit without knowing the actual physical memory address. The logical starting address stored in the table is the address the memory region begins at as seen from the subsystem.
Physical starting address: This value is only known by the memory management unit and stores the actual physical starting address of a memory region. The required transfer between subsystem logical memory addresses and physical addresses for e.g. read and write requests is performed by the memory management unit in both directions. In this way, the actual physical memory implementation is invisible to all subsystems, which therefore all have a unified view of the available memory resources.
Size: The size of a memory region is indicated in this parameter value. A basic unit for the size value may be predefined as suitable, such as the bit width of the memory interface between memory system and subsystems. This parameter value is e.g. used by the subsystems requesting memory resources to indicate the required size and is then stored in the parameter table at the IMMU for each memory region. This implies that memory regions may vary in size.
Performance grade: A memory region may be assigned a performance grade that reflects various required performance values. In a simple form, this may for example be an integer number that is defined as follows:
   0=no performance requirements
   1=requires a memory block only accessible to a single subsystem
   2=at most two subsystems may have regions in the block
   3=at most three subsystems may have regions in the block
   and so forth. In a more advanced implementation, the performance grade may be a number derived from several values for defining the required bandwidth, latency, jitter, media type (sequential/random access) and a configurable number of other parameters.
Protection flag: A memory region may be reserved for a single user (protected) or available to all users (non protected). The value may for example be given as a binary flag, with a value of 1 for a protected region and 0 for a non-protected region. If a memory region is not protected, its ownership may be allocated to several subsystems giving the correct region code, i.e. the region code that was defined at the first allocation and given to the respective subsystem. Since a subsystem still needs the correct region code, this feature may optionally be used for restricting access to an unprotected memory region. A region code may be passed to another subsystem as described below in connection with ownership transfer (see also FIG. 4).
Hard-coded/changeable: This value indicates whether the allocation of a memory region can be changed or not. Similarly to the “protected” flag, this may be done by a binary flag having a value of 1 for a hard-coded memory region and 0 for a changeable allocated memory region. By means of this parameter, dedicated allocations of global memories for single subsystems may be effected.

Further parameters may be defined that could e.g. be user defined or vendor specific for various purposes. All of the parameters and implementation examples presented above are given by way of example only and may also be realized differently. All parameters are updated by the memory management unit if some attribute of a memory region has been changed, e.g. by a deallocation or a region transfer. Also, all values may be stored into the IMMU table during system boot.

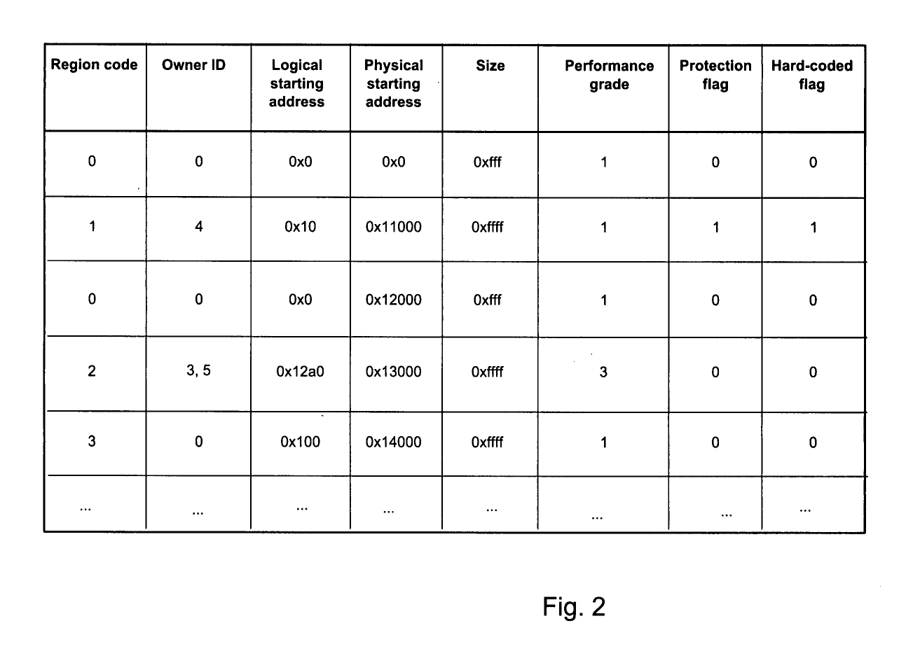

FIG. 2 shows an example of a parameter table that could be used by the memory management unit IMMU to control the memory resources. Parameters as defined above are shown in columns, while each row corresponds to a memory region. Several regions may have a region code of 0 in this example which means that the corresponding region is currently unallocated. Any other region code should only appear once to enable an unambiguous identification of a memory region. The second column indicates the current owner of a memory region. One subsystem (having an unique subsystem ID) may be an owner of several memory regions, and also a single memory region that is not protected may have several owners, as e.g. shown in line 4 of the example table, where subsystems “3” and “5” are indicated as current owners of a memory region having the region code 2.

Columns three and four show logical and physical starting addresses of the memory regions, respectively. As mentioned above, the memory management unit is able to translate logical addresses for the subsystems into physical memory addresses.

In column five, the size of each memory region is indicated. In this example, there are two unallocated regions of a first size and three allocated regions of a second size; however, these are only examples, and the size of a memory region may be variable and may also optionally be changed during operation. This may for example be the case when only part of a region needs to be transferred or de-allocated.

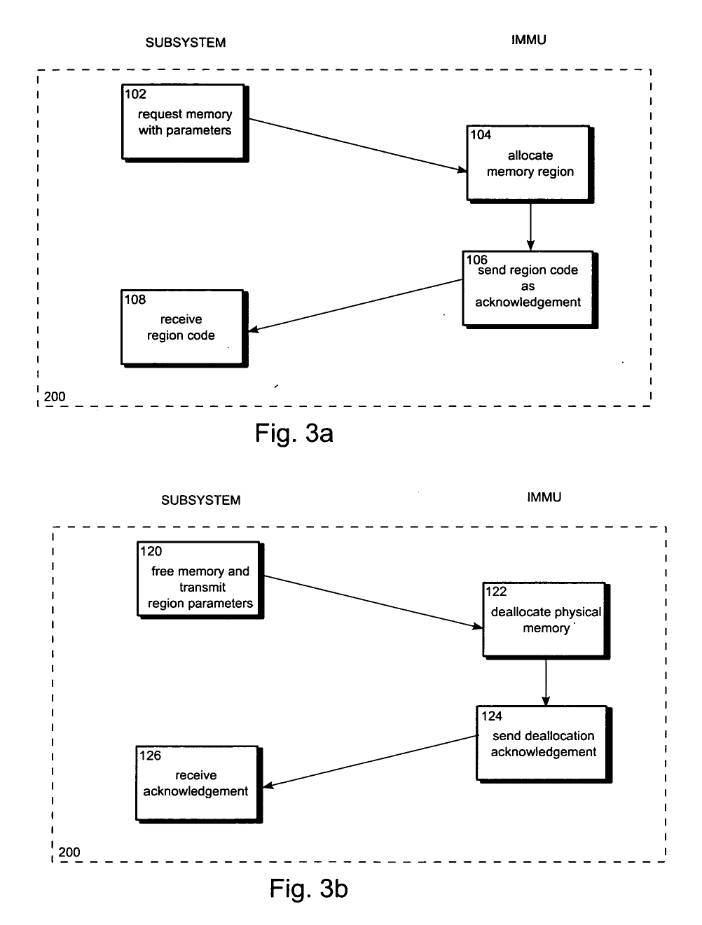

Basic functions of an exemplary system according to the invention include allocation and deallocation of memory to subsystems (FIG. 3), transfer of memory region ownerships between different subsystems (FIG. 4), as well as read and write procedures. These functionalities will now be discussed with some examples, along with some special cases.

Referring to FIG. 3a, a subsystem that requires a certain amount of memory will issue a request for memory through the memory interface (MI). For this purpose, the request (step 102) may for example comprise parameters as the subsystem ID, the logical starting address, the required size, protected or non-protected flag, and the required performance grade. The IMMU will allocate available physical memory in response to the received request from the subsystem in step 104 and subsequently in step 106 acknowledge the performed allocation by relaying the region code associated with this allocated memory region to the subsystem. The subsystem will receive the region code in step 108 and may then start using the allocated memory region.

Deallocation of memory from a subsystem may be performed in a similar way, illustrated in FIG. 3b. When memory that is currently allocated to a subsystem is no longer in use and thus may be freed, the corresponding subsystem ID and region code for this memory region are transmitted to the IMMU via the memory interface MI in step 120. The IMMU will deallocate the indicated memory region (step 122) and send an acknowledgement (124) of the deallocation to the subsystem. Alternatively, only a part of a memory region may be de-allocated. In this case, the logical starting address and size parameters at the IMMU would be changed, generating new rows in the IMMU table as the previous memory region is then split into two parts. Afterwards, the de-allocated part may be treated just like another non-allocated memory region with its own region code.

A further function of exemplary embodiments of the invention is transfer of a memory region ownership. That is, a memory region is allocated to a first subsystem SS1 as described above, and subsequently transferred to a second subsystem SS2 without any intermediate deallocation/allocation step. This is illustrated by example in FIG. 4. The first step 200 corresponds to the steps of FIG. 3, i.e. a request for memory with specified parameters, upon which the IMMU will allocate a physical memory region and send back the region code as an acknowledgement. Step 200 in this example should therefore be understood to include all steps necessary for allocation of a memory region as e.g. shown in FIG. 3a.

If then the first subsystem is not in need of the allocated memory region any more and the data located in the memory region is required by a second subsystem, the first subsystem may transfer the ownership to a second subsystem. At that time, the ownership of the respective memory region is defined by the parameter “owner ID” in the IMMU table, having a value of the first subsystem ID. It should be noted that an unprotected memory region may also be owned by more than one subsystem, that is, several subsystems may have access to the allocated memory region and are thus defined as parameter values for the owner ID.

In exemplary embodiments of the invention, the ownership transfer itself is achieved as illustrated in the following with regard to FIG. 4. Initially in step 202, the first subsystem SS1 transmits to the memory management unit IMMU its subsystem identifier and the region code of the memory region the ownership of which is to be transferred. In response, the IMMU removes the subsystem identifier from the owner ID field of the parameter table (or alternatively defines the ownership as removed in some other way) in step 204. Otherwise, the parameter table remains unchanged, that is, size, region code and any further parameters are not touched. Subsequently, the IMMU may send an acknowledgement to the subsystem to confirm the removal in step 206, which is received at the first subsystem SS1 in step 208. All these messages/data are transmitted via the logical memory interface MI in this exemplary embodiment.

In a second segment, the memory region is transferred from a first subsystem SS1 to a second subsystem SS2 by communicating its respective parameters in step 210. The communicated parameters may for example include size, performance grade, protection flag and the region code of the memory region to be transferred. The second subsystem SS2 receives the parameters in step 212 and may acknowledge the transfer by another communication (step 214) to the first subsystem. This part of the transfer procedure, that is the communication between first and second subsystems, is performed via the control interface CI.

As a last part, the second subsystem SS2 registers as a new owner of the memory region to the memory management unit IMMU by transmitting via the memory interface MI the region code and logical starting address of the region along with its subsystem identifier to the IMMU in step 218, which in response (step 220) updates the IMMU table with the new parameter values for owner ID and logical address, while all other parameters remain unchanged. Finally, the IMMU may acknowledge the ownership update by an acknowledgement signal or message to the second subsystem SS2 in step 222. Now the subsystem may access the memory region as usual.

The transfer procedure as illustrated above is only given by way of example and may vary in various embodiments of the invention. For example, acknowledgements may not be required or steps such as sending an acknowledgement and registering with the IMMU might be performed simultaneously. Also, further messages and/or parameters might be transmitted to achieve the transfer of the memory region code to another subsystem. Instead of a first memory allocation (step 200) right before the region transfer, another similar region transfer (or several region transfers) from another subsystem may have been performed beforehand. Many other modifications of the method are conceivable to a person skilled in the art.

In the above example, ownership of a complete and unchanged memory region was transferred to another subsystem. However, also only fractions of a memory region may be transferred or de-allocated, as already mentioned above. In case of a partial transfer of a memory region, size and starting address of the transferred portion (or alternatively of the portion not to be transferred) are transmitted with the further parameters. The IMMU may then change the parameter table by creating a new row for the cut-off part of the memory region and updating the parameters of the old region, thus creating a new region of smaller size, which may then be transferred or allocated as before.

In an alternative embodiment, the first subsystem may not return the ownership of a memory region until the second subsystem SS2 has registered as a new owner at the IMMU. That is, for example all steps relating to the region code transfer between both subsystems might be performed before the transfer request to the IMMU.

All further procedures, such as read and write procedures to the memory are performed in the way known in the art, with the exception that the IMMU may be able to block access to unallocated and protected memory regions. The translation between physical and logical addresses for all procedures is done by the IMMU. As an example, each read or write procedure requires a command for identification of the read/write type, a user ID and an address.

If several operations arrive at the IMMU simultaneously, they will be processed sequentially. Processing order may be based on known schemes such as priority arbitration, round-robin, reserved time-slot scheme or any combination of these. Alternatively, a user may be allowed to define a custom arbitration scheme.

Some memory parts may be dedicated to a specific subsystem, which may be hard-coded in the IMMU. As described above, such a dedicated memory region may be indicated by a parameter in the IMMU table. In addition to the memory managed by the IMMU, a subsystem may further have access to internal memory that is not controlled or even seen by the IMMU. The internal memory of a subsystem may be located within the same physical memory element as the IMMU controlled memory or alternatively on separate physical memory units.

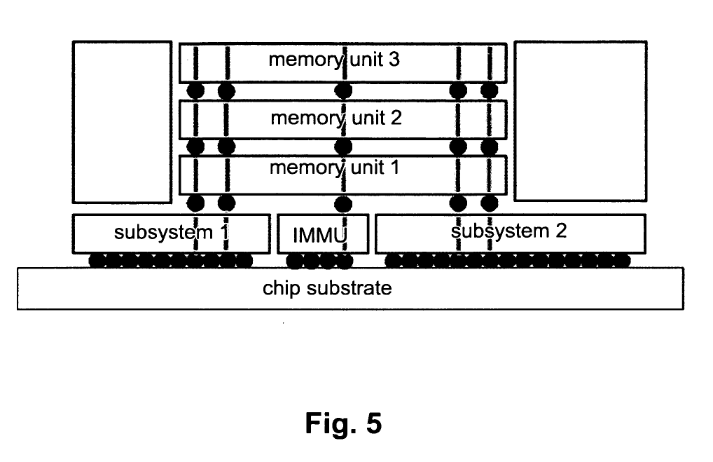

In general, the invention as described by way of example above may be physically implemented in various schemes. One example will now be described with reference to FIG. 5. In this scheme, a DRAM (dynamic random access memory) and subsystems are provided on a chip substrate and connected face-to-face. This allows the use of extremely wide buses, up to thousands of bits wide. The memory interface MI is implemented through the face-to-face interface, and the control interface CI through the chip substrate. Several DRAM dies, i.e. memory units, may be stacked vertically and provided with silicon-through-VIAs or some other suitable connection elements for connecting the DRAM units to the subsystems and the memory management unit. In such a stacked die implementation, a two-part addressing scheme may be required, wherein the first part comprises an identification of the memory die and the second one comprises the address within the respective memory die. The logical architecture regarding the different interfaces and connections is as shown before in FIG. 1.

The fact that the actual memory implementation is hidden from the subsystems by the memory management unit facilitates the optional use of heterogeneous memory structures in a device. Not only DRAM units as described in the example above may be used, but also combinations of different memory architectures and types. For example, the complete memory system that is managed by the IMMU might include volatile storage types such as DRAM and SRAM, but also non-volatile elements such as flash memory or hard disks.

The physical addresses of the allocated memory regions are selected based on performance requirements given by the subsystems. The distinct memory blocks forming the global memory system may vary in available bandwidth, latency, memory size, or power consumption. In addition, some memory blocks might have more users than others.

To avoid memory fragmentation, the memory may need to be rearranged in certain intervals. All memory accesses may be stalled until the rearrangement procedure is completed. This may also be done if at an allocation request there is no memory region of sufficient size.

Garbage collection may be performed if the amount of unallocated memory is less than a certain percentage of total memory. In this process all transferred and currently non-registered memory regions are marked as free if they have been unused for y clock cycles, with y being a configurable value. After this, the memory is defragmented.

The data flowing from the subsystems into a memory can be processed by the IMMU if required. This processing may include calculating error detection or correction codes, compressing the data, or utilizing some other signal processing algorithm to transform the data into another form.

In the system, various error messages may be defined for handling special situations that may occur during operation. Some examples are described in the following.

For instance, the available memory may be less than the amount of memory requested by a subsystem. In that case, the memory management unit may in an exemplary embodiment of the invention try to allocate a smaller memory portion and extend this portion as soon as more resources are available again.

Another example would be that the performance grade that was required by the requesting subsystem by means of the performance parameter included in the request cannot be met.

As mentioned above, memory performance may relate to bandwidth, number of concurrent owners/users, and similar characteristics. One possibility to handle such an error according to an exemplary embodiment may be that a memory region with lower performance is allocated at first, again with an option to extend or change the allocated memory region as soon as suitable memory portions are released.

In any case, it is not necessarily required to wait until another memory portion is in fact de-allocated. If a memory region's state is changed from protected to unprotected, this also provides the system with the possibility to allow access of this now unprotected memory region to another subsystem.

If a subsystem attempts to register as a new owner of an untransferred memory region, it may receive an error message to indicate that the given parameters are not correct, and thus requesting the subsystem to re-register with correct parameters. It would also be possible to retry registering after a certain time to ensure that the transfer request of the previous region owner has been completed at the IMMU.

When memory is being defragmented or garbage collection is performed, access to the respective memory regions will be stalled and an error message may be communicated to any subsystem that tries to access the memory region, indicating to try again at a later moment.

All embodiments, descriptions and explanations above should not be understood as limiting, but were given by way of example only to enable an understanding of the invention. All features and details described for a specific embodiment may be transferred and combined with any of the further described embodiments, as long as they are not mutually exclusive. A person skilled in the art will easily see that many modifications, improvements, and various combinations of the above embodiments are possible without departing from the spirit and scope of the invention.

What is claimed is:

1. A method comprising:
allocating a first memory region to a first subsystem;
generating a region code associated with said allocated memory region;
storing said region code in connection with an address of said memory region; and
defining said first subsystem as a first owner for said memory region by storing a unique subsystem identifier together with said region code in a parameter table.

2. The method of claim 1, wherein said allocating comprises receiving a request for memory resources from said subsystem, and allocating a memory region corresponding to said request for said subsystem, and wherein the method further comprises transmitting said generated region code of said memory region to said subsystem as an acknowledgement.

3. The method of claim 2, wherein said request for memory resources comprises at least a required size parameter and a logical starting address parameter for said memory region.

4. The method of claim 1, further comprising transferring ownership of said memory region to a second subsystem by changing said stored subsystem identifier at said parameter table.

5. The method of claim 4, wherein said ownership transfer of said memory region comprises:
transmitting an ownership transfer request for said memory region by said first subsystem to a central memory management unit;
transmitting a region parameter message from said first subsystem to said second subsystem; and
said second subsystem transmitting an update ownership request for said memory region to said memory management unit.

6. The method of claim 5, wherein said ownership transfer request includes said subsystem identifier of said first subsystem and said assigned region code of said memory region to be transferred.

7. The method of claim 5, wherein said update ownership request includes as parameters at least said subsystem identifier of said second subsystem, said region code of said transferred memory region and a logical starting address of said memory region of said second subsystem.

8. The method of claim 7, wherein said subsystem identifier and said region code included in said update ownership request were received in said region parameter message.

9. The method of claim 7, wherein said region parameter message is transferred between subsystems.

10. The method of claim 6, further comprising said memory management unit removing said subsystem identifier indicated in said ownership transfer request from said stored parameter table.

11. The method of claim 7, further comprising
said memory management unit updating said stored parameter table according to said parameters included within said update ownership request.

12. The method of claim 1, further comprising said memory management unit blocking any memory access for a specific subsystem to a memory region if the subsystem identifier of said specific subsystem does not match at least one subsystem identifier stored in connection with the region code of said memory region.

13. The method of claim 1, wherein said parameter table stored at said memory management unit comprises one or more of the following values for at least one memory region: memory region size, memory region code, owner identifier, logical starting address of said memory region, physical starting address of said memory region, protection flag, hard-coded flag.

14. The method of claim 12, further comprising:
changing the size of an allocated memory region by updating a region size parameter stored in said parameter table, and
adding an entry to said parameter table comprising parameters of a new memory region, wherein said new memory region is a part of said allocated memory region.

15. A system comprising:
at least one subsystem;
at least one memory unit;
a memory management unit connected to said at least one subsystem and said at least one memory unit, having a stored parameter table comprising memory allocation related parameters; and
at least one data interface for communication between said at least one memory unit and said at least one subsystem via said memory management unit,
wherein said memory management unit is configured to generate and store unique region codes for each memory region of said at least one memory unit that is allocated to one of said at least one subsystems.

16. The system of claim 15, wherein said at least one subsystem is a logic processing semiconductor die.

17. The system of claim 15, wherein said at least one memory unit is a DRAM module.

18. The system of claim 15, wherein said at least one memory unit and said at least one subsystem are separate dies integrated into a single chip package and connected to each other.

19. The system of claim 18, wherein said at least one memory unit is attached by a face-to-face-connection to said at least one subsystem.

20. The system of claim 19, further comprising silicon-through-VIAs for providing connections between said memory units and said subsystems.

21. The system of claim 15, wherein said memory management unit is arranged to transfer ownership of a memory region by changing a subsystem identifier stored in said parameter table.

22. The system of claim 15, further comprising at least one second subsystem which is capable of transmitting an ownership request message for a memory region to said memory management unit.

23. The system of claim 15, further comprising a logical data interface for communication between at least two subsystems, wherein said first subsystem is arranged to transmit a region parameter message to said second subsystem.

24. An apparatus comprising a system according to claim 15.

25. The apparatus of claim 24, wherein said apparatus is one of:
a mobile/portable device;
a mobile communication terminal;
a personal or laptop computer; and
a media player.

26. A computer readable medium comprising computer program code configured to perform the method of claim 1 when executed on a processor.

27. A system comprising:
means for allocating a first memory region to a first requesting subsystem;
means for generating a region code associated with said allocated memory region;
means for storing said region code in connection with an address of said memory region; and
means for defining said first subsystem as a first owner for said memory region by storing a unique subsystem identifier together with said region code.

28. The system of claim 27, further comprising means for transferring ownership of said memory region to a second subsystem by changing said stored subsystem identifier at said parameter table.

29. The system of claim 27, further comprising means for transmitting messages containing at least one parameter related to memory regions between a subsystem and further units of said system.
